(19) United States
(12) Patent Application Publication
(10) Pub. No.: US 2023/0331358 A1
(43) Pub. Date: Oct. 19, 2023

(54) FLOATING PLATFORM FOR SUPPORTING OFFSHORE POWER GENERATION STRUCTURES AND METHOD FOR MAKING SAID PLATFORM

(71) Applicant: SEAWIND OCEAN TECHNOLOGY HOLDING B.V., Amsterdam (NL)

(72) Inventors: Silvestro CARUSO, Amsterdam (NL); Eugenio BARBIANO DI BELGIOJOSO, Amsterdam (NL); Martin JAKUBOWSKI, Amsterdam (NL)

(21) Appl. No.: 17/999,224

(22) PCT Filed: May 19, 2021
(86) PCT No.: PCT/IB2021/054331

§ 371 Date: Nov. 18, 2022

(30) Foreign Application Priority Data
May 20, 2020 (IT) 102020000011779

(51) Int. Cl. B63B 75/00; B63B 5/16; B63B 5/20

(52) U.S. Cl. CPC B63B 75/00; B63B 5/16; B63B 5/20; B63B 2035/446

(57) ABSTRACT

A floating platform (1) to support offshore structures intended to generate electricity, this platform comprising a load-bearing support base (2) made of concrete and defining a longitudinal axis (L), this support base (2) being provided with three vertices (3, 4, 5) and an intermediate point (6) located near its geometric center; a plurality of vertical bodies (8) made of concrete which extend from the support base (5) at said vertices (3, 4, 5) and at the intermediate point (6). A vertex (3) of the load-bearing support base (2) is arranged in a longitudinally forward position with respect to the other two vertices (3, 4) and the load-bearing support base (2) comprises a pair of main connection arms (18) suited to directly connect the vertex (3) in a longitudinally forward position with respect to the other two vertices (3, 4) so as to define a substantially arrow-like shape in plan view. A method for the construction of a floating platform (1) to support offshore structures intended to generate electricity.

### FIELD OF APPLICATION OF THE INVENTION

The present invention concerns the technical sector of load bearing structures and more specifically it concerns a semi-submersible floating platform made of concrete for the installation of offshore power generation systems.

The invention also concerns a method for making a semi-submersible concrete floating platform.

### STATE OF THE ART

As is known, nowadays offshore power parks are mainly composed of wind turbines installed in shallow waters, which therefore have their supporting structure secured to the sea bottom.

In the near future most wind parks will be installed in medium deep or very deep waters.

In this type of installation, the most economically advantageous solution is the installation of the conversion system on a semi-submersible floating platform anchored to the sea bottom with suitable mooring lines.

In some cases the platforms are made of steel, but this type of structure has both economic and technical drawbacks.

In particular, these structures have high construction costs and do not allow the overall center of gravity of the system to be lowered, which limits the stability of the wind turbine during its operation in the sea.

The alternative to steel is concrete; in fact, if suitably configured, a platform made of concrete has lower construction costs and makes it possible to lower the center of gravity of the system, thus providing more stability during operation.

It should be highlighted that floating platforms are constructed in building sites located near the coast and subsequently towed into the sea and to the installation site. It is also possible to assemble a complete power generation system at the building site and then tow it to the installation site. This prevents the need for costly marine hoisting equipment.

A structure with a low center of gravity (as can be obtained using concrete) enables these operations.

A further advantage of concrete platforms is that their mass makes it possible to obtain a specific oscillation period of the system in the water which exceeds the maximum period of the waves (as expected in the installation site). In this way it is possible to exclude or minimize any dynamic interaction between the waves and the platform.

Finally, a suitably configured and sized concrete platform makes it possible to obtain a high momentum of torsional inertia to the benefit of a wind turbine control system.

The reduced construction cost of concrete platforms, however, largely depends on the degree to which their structural configuration permits the use of a low cost industrial construction process.

The existing configurations of concrete platforms are not designed to be constructed with an industrial process suited to minimize their construction costs.

Marine power exploitation technology is current undergoing a significant development phase. However, it is not suited to be used in deep waters, as it would require the preparation of costly support systems.

If the concrete platform of a wind turbine is also configured to accommodate the elements of the marine power conversion system, the (synergic) combination of both conversion systems, wind and marine, makes the whole highly profitable.

It is known that the action of the wind and waves on the conversion system is generally prevailing within a certain angular range for a given direction, according to the compass rose and the waves at the site.

The economically advantageous nature of an offshore conversion system also depends on the lifespan of its supporting structure. A platform designed to last for fifty years can be used for two life cycles of the conversion system (each cycle has a duration of twenty-five years).

In this case, at the end of each cycle the system could be towed to the assembly site, where it would be possible to change the tower, the wind turbine and the marine power conversion system, to inspect the structures of the platform externally and internally, and if necessary to recondition them.

This object can be achieved only if the platform is optimized in such a way as to minimize oscillations and fatigue loads, in particular when the waves and the wind stress the structure from their prevailing direction.

In other words, the platform must be optimized in such a way that the stresses/oscillations produced by the wind and the waves coming from any direction are acceptable and those generated by the wind and the waves along their prevailing direction are minimal.

The platforms of the prior art are not conceived or designed to achieve these objects.

Furthermore, the possibility to inspect a platform is critical for the verification of the structures during its entire useful life (especially in the case of platforms designed for a double life cycle).

There is no evidence relating to the fact that the concrete platforms of the prior art are designed to allow access to and inspection of all their parts.

The conversion system supported by the platform is generally equipped with systems intended for cooling the electrical equipment.

A semi-submerged floating platform, however, can be conceived to accommodate the electrical equipment in such a position that it can be cooled by a heat sink cooled by the water in which the platform is immersed.

The reliability of the mooring system is another important factor for a floating platform. In fact, the most effective method to achieve a good level of reliability is the use of redundant mooring lines, consisting of three pairs of lines arranged in such a way as to prevent contact with each other during operation.

Patent documents US2015/329180, JP2006327252 describe a semi-submersible floating platform having all the characteristics described in the preamble of the main claim regarding a platform. Furthermore, documents WO2018/185309, WO2015/048147, WO2016/172149, CN107963186, FR3064694, FR2970748 and US2018/105235 describe floating structures having some technical characteristics in common with those described in the independent claims of the present patent application.

However, the documents mentioned above described the same drawbacks identified above, that is, the inability of these structures to minimize the oscillations and the fatigue of the structure when the waves and the wind stress it in their prevailing directions (that is, the inability to make the stresses/oscillations produced by the wind and the waves coming from any direction acceptable and to minimize those produced by the wind and the waves along their prevailing direction).

Furthermore, the reliability of the structures described in the above patents is limited and in order to overcome this drawback it is necessary to use redundant mooring lines, constituted by three pairs of lines arranged in such a way as to prevent their contact during operation.

### Presentation of the Invention

The present invention intends to overcome the technical drawbacks mentioned above providing for a semi-submersible floating platform made of concrete for offshore power conversion systems which makes it possible to drastically reduce production times and costs.

Another object of the present invention is to provide a semi-submersible floating platform made of concrete for offshore power conversion systems the lifespan of which is intended to be twice the lifespan of energy conversion systems of the prior art.

Still another object of the present invention is to provide a semi-submersible floating platform made of concrete for offshore power conversion systems having high stability when towed in the sea even for long distances.

A further object of the present invention is to provide a semi-submersible floating platform made of concrete for offshore power conversion systems which makes it possible to install a combined system for the conversion of wind and sea energy.

Yet another object of the present invention is to provide a semi-submersible floating platform made of concrete for offshore power conversion systems with a relatively low center of gravity and a high momentum of inertia around the vertical axis.

Still another object of the present invention is to provide a semi-submersible floating platform made of concrete for offshore power conversion systems which makes it possible to minimize the stress generated by the waves and wind acting in their prevailing direction.

A further object of the present invention is to provide a semi-submersible floating platform made of concrete for offshore power conversion systems the shape of which in plan view is such as to simplify its construction while ensuring adequate resistance to the stress generated by the waves and wind acting in their prevailing direction.

Yet another object of the present invention is to provide a semi-submersible floating platform for offshore power conversion systems suited to minimize both the pitching and the rolling oscillations caused by the waves and wind acting in their prevailing direction.

These and other objects which are described in greater detail below are achieved by a semi-submersible floating platform made of concrete for offshore power conversion systems of the type according to claim 1.

Other objects which are better clarified below are achieved by a semi-submersible floating platform made of concrete for offshore power conversion systems of the type according to the dependent claims.

The invention also comprises a method for making a semi-submersible floating platform made of concrete for offshore power conversion systems of the type according to claim 15.

### BRIEF DESCRIPTION OF THE DRAWINGS

The advantages and characteristics of the present invention will clearly emerge from the following detailed description of some preferred but non-limiting embodiments of semi-submersible floating platforms for offshore power conversion systems with particular reference to the following drawings:

FIG. 1 shows a perspective view of a first embodiment of a floating platform to support offshore structures designed to generate electric energy;

FIG. 2 shows a top view of the floating platform of FIG. 1;

FIG. 3 shows a perspective side view of the platform of FIG. 1;

FIG. 4 shows a perspective view of the platform of FIG. 1 in which the position of the marine energy converters is visible;

FIG. 5 shows a perspective sectional view of the platform of FIG. 1 in which the position of the electrical system of the turbine is visible;

FIG. 6 shows a perspective plan view of the supporting base of the platform shown in FIG. 1;

FIG. 7 shows a perspective plan view of the base of FIG. 6 where the upper side of the arms was removed;

FIG. 8 shows a perspective view of a second embodiment of a floating platform suited to support offshore structures intended to generate electric energy;

FIG. 9 shows a perspective plan view of the supporting base of the platform shown in FIG. 8;

FIG. 10 shows a plan view of the base of FIG. 9 where the upper side of the arms was removed;

FIG. 11 shows a perspective plan view of the base slab of the platform after its construction;

FIG. 12 shows formworks and reinforcing elements assembled in a sandwich configuration to create the supporting base of the floating platform of FIG. 1 as an example of the method for making the entire platform.

### DETAILED DESCRIPTION OF THE INVENTION

The subject of the present invention is a semi-submersible floating platform designed to support offshore power generation structures. More specifically, the floating structure described below is suited to support a wind turbine and is also designed, as described in greater detail further on in the description, to support a marine energy converter.

The floating platform which is the subject of the present invention is particularly suited to be used for systems operating in the open sea at a depth exceeding fifty meters and furthermore, is completely made of steel reinforced concrete (with the possible prefabrication of some parts including post-tensioned parts if necessary).

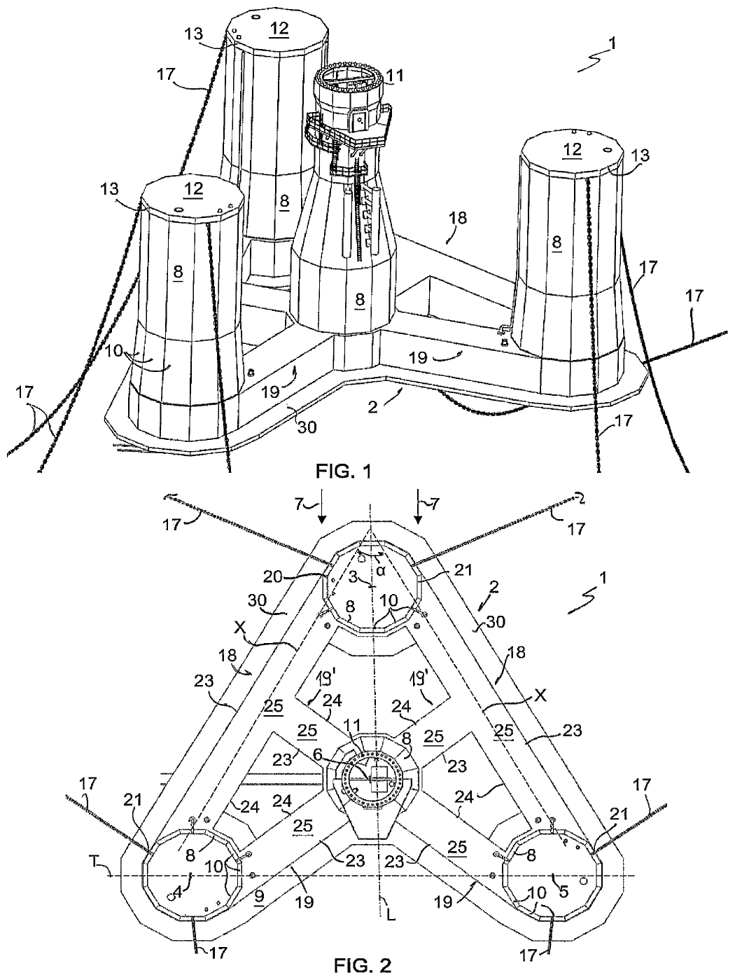

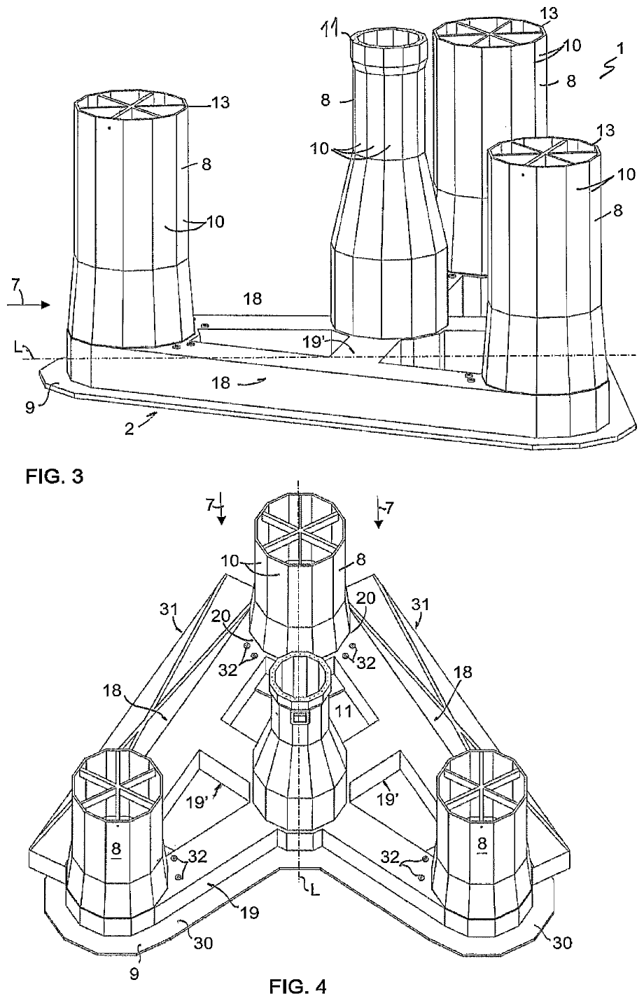

FIGS. 1 to 5 illustrate a preferred embodiment of the floating platform which is the subject of the present invention and indicated therein as a whole by the reference number 1.

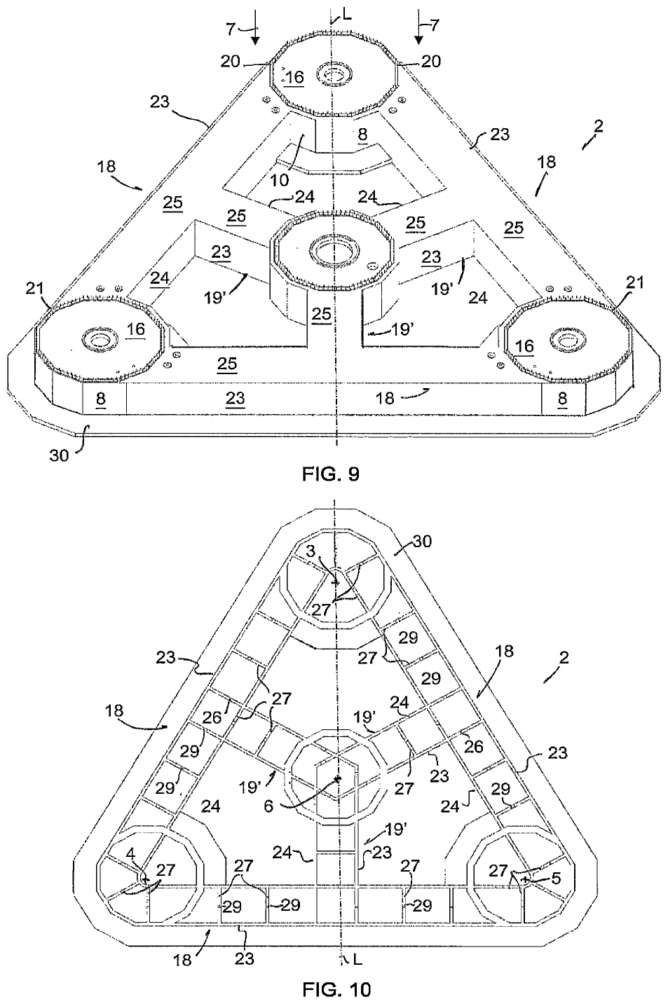

Said platform comprises a load-bearing support base 2 which extends along a longitudinal axis L and is also visible in FIGS. 6 to 9 in addition to the aforementioned figures.

The geometrical structure of the support base 2 has three vertices 3, 4, 5 positioned at the ends and an intermediate point 6 positioned within the base 2, in proximity to its geometrical center.

The expression “intermediate point” is used to indicate a point that does not actually represent the geometrical center of the base but a point located within the triangular area formed by the three vertices 3, 4, 5.

Conveniently, when the platform 1 is positioned in the open sea the longitudinal axis L of the base is oriented parallel to the prevailing direction of the waves and the wind (indicated by an arrow with reference number 7 in the figures) and with its vertex 3 positioned contrary to the direction of movement of the waves.

In other words, the platform is designed to be oriented in such a way that the waves and the wind (in their prevailing direction) first hit the vertex 3 (which, therefore, is in a longitudinally forward position with respect to the other two vertices 4, 5).

Conveniently, as better seen in FIG. 2, the two vertices 4, 5 are in a rear position with respect to the vertex 3 and are arranged along a substantially common transverse direction T.

The concrete platform 1 comprises four vertical bodies 8 (consisting of hollow vertical bodies with a polygonal cross-section), connected to each other by a lattice of arms (better described below) and with a slab 9 in common.

The four internally hollow vertical bodies 8 are positioned at the vertices 3, 4, 5 and at the intermediate point 6.

The walls of the vertical bodies 8 have a closed cross section and a substantially regular polygon shape.

Each side 10 of the polygonal wall of a vertical body 8 has a maximum width of about 2.5 meters so as to allow its construction using flat formworks that can be transported inside containers, as will be better described in the following description.

As properly illustrated in FIGS. 1 to 5, the vertical bodies 8 extend upwards without interruption starting from the slab 9 of the support base 2, maintaining their polygonal configuration along their way up.

In FIG. 8 the slab 9 of the support base 2 is clearly visible; the slab 9 is the bottom wall of each vertical body 8 and of the lattice of arms.

The slab 9 is substantially thicker than the other walls that make up the support base 2 so as to improve the stiffness of the structure of the entire platform 1 (which can also be improved with transverse reinforcements inside the bottom walls of the vertical bodies 8).

All the vertical bodies 8 are watertight; they also have the function of creating the hydrostatic thrust necessary to keep the system in a vertical position.

The vertical bodies 8 positioned on the vertices 3, 4, 5 also have the function of modifying the distribution of the hydrostatic thrust to generate a righting moment in opposition to the overturning moments caused by the action of the wind on the turbine rotor and of the waves on the platform.

The vertical body 8 of the intermediate point 6, one of the components subject to the most severe stress, can have a configuration consisting of cylindrical polygonal sections and truncated-conical polygonal sections and may require post-tensioning cables.

This specific vertical body 8 supports the steel tower of the turbine (not visible in the figures), to which it is connected by means of a metal transition joint 11. The dimensions of the vertical body 8 positioned on the intermediate point 6 and those of the overlying tower are also determined taking into account the need to minimize the dynamic interactions that are generated between them and the motion of the turbine rotor.

The vertical bodies 8 placed at the vertices 3, 4, 5 extend from the slab 9 of the support base 2 up to above sea level and are equipped with a lid 12 suited to close the end 13.

The dimensions of the vertical bodies 8 and their distance from each other are such as to keep the system in a stable position at sea with the platform 1 partially submerged and to limit the pitch and roll angles within values acceptable for the wind turbine.

Conveniently, the vertical body 8 positioned on the intermediate point 6 also has the function of housing the electrical system of the converters, indicated as a whole with the reference number 14 which is predominantly located below sea level.

In this way it will be possible to facilitate the cooling of the electrical equipment 14 by means of the heat sink produced by the sea through the wall of the hollow vertical body 8 which contains it.

A hatch 15 is also provided for access to the inside of the tower near the upper end 13 of the vertical body 8 positioned on the intermediate point 6.

The four vertical bodies 8 may comprise internal stiffening elements 16 consisting of an annular transverse structure arranged at the height of the lattice covers of the arms 18, 19, 19′. Furthermore, the vertical body 8 located on the intermediate point 6 may contain both internal stiffening structures 45 constituted by the extension towards the inside of the arms to which it is connected and extra thicknesses at its truncated-conical polygonal area and its top. The vertical bodies 8 placed on the vertices 3, 4, 5 may comprise internal reinforcements 46 at their base and further reinforcements placed at their top to connect the mooring lines 17.

As noted above, the support base 2 may comprise a slab 9 defining the lower wall on which all the elements of the platform are placed.

In particular, this slab 9 may have a predetermined thickness and shape in a plan view.

To increase the overall stability of the platform 1 and, at the same time, minimize the stresses induced by the waves and the wind acting in the prevailing direction of the wind turbine, the layout of the slab 9 will be such as to connect all vertices 3, 4, 5 to the intermediate point 6.

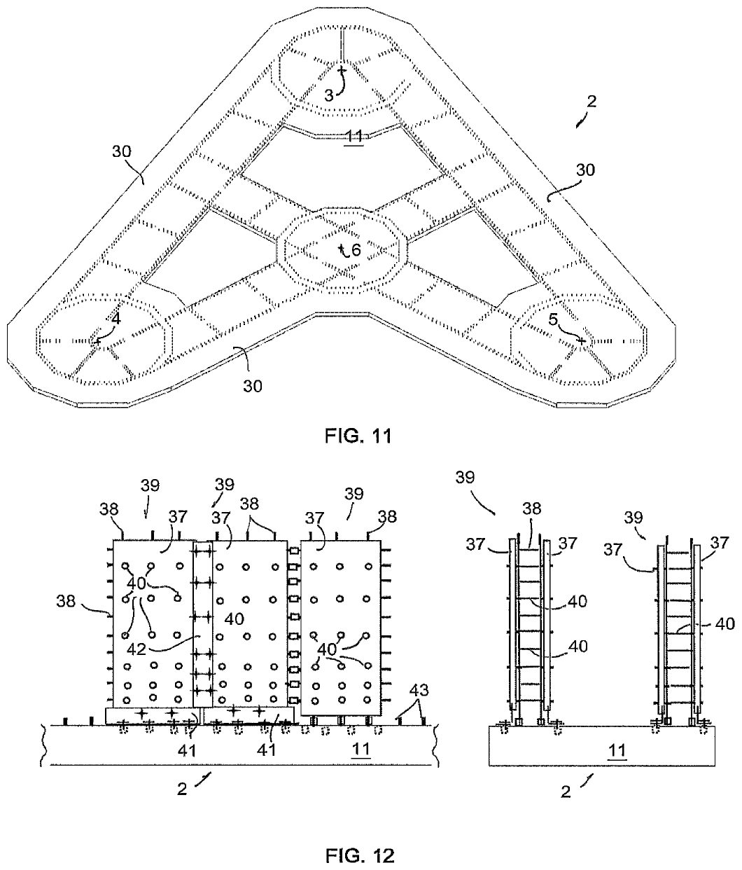

For example, the slab 9 associated with the platform illustrated in FIGS. 1, 2, 4, 6, 7 and 11 has a substantially “arrow-like” layout so as to connect all the vertices 3, 4, 5 to the intermediate point 6 (by the slab itself).

The slab 9 illustrated in FIGS. 8 to 10 has a substantially triangular layout but also in this case all vertices 3, 4, 5 are connected to the intermediate point 6 (by the slab itself).

The platform 1 comprises a plurality of connection arms 18, 19, 19′ suited to connect the vertical bodies 8 to each other through the slab 9 so as to define an integral and unitary support base 2.

In particular, the support base 2 shown in the Figures has a pair of main connection arms 18 intended to connect the vertices 3, 4, 5 to each other in the following manner:
one end 20 of these connection arms 18 is connected to the vertical body 8 located at the vertex 3 (placed in a forward position);
the other end 21 of these connection arms 18 is connected to a corresponding vertical body 8 located at the vertex 4, 5 (placed in a rearward position).

The main connection arms 18 have a substantially rectilinear shape to allow the vertices 3, 4, 5 (and the corresponding vertical bodies 8) to be connected to each other in a direct manner. In other words, these connection arms 18 extend along a rectilinear direction X which connects the vertices 3, 4, 5 to each other without intersecting the intermediate point 6.

The particular geometry of the main connection arms 18 defines a layout of the substantially arrow-shaped base (clearly visible in FIG. 2) in which the forward vertex 3 is the pointed end.

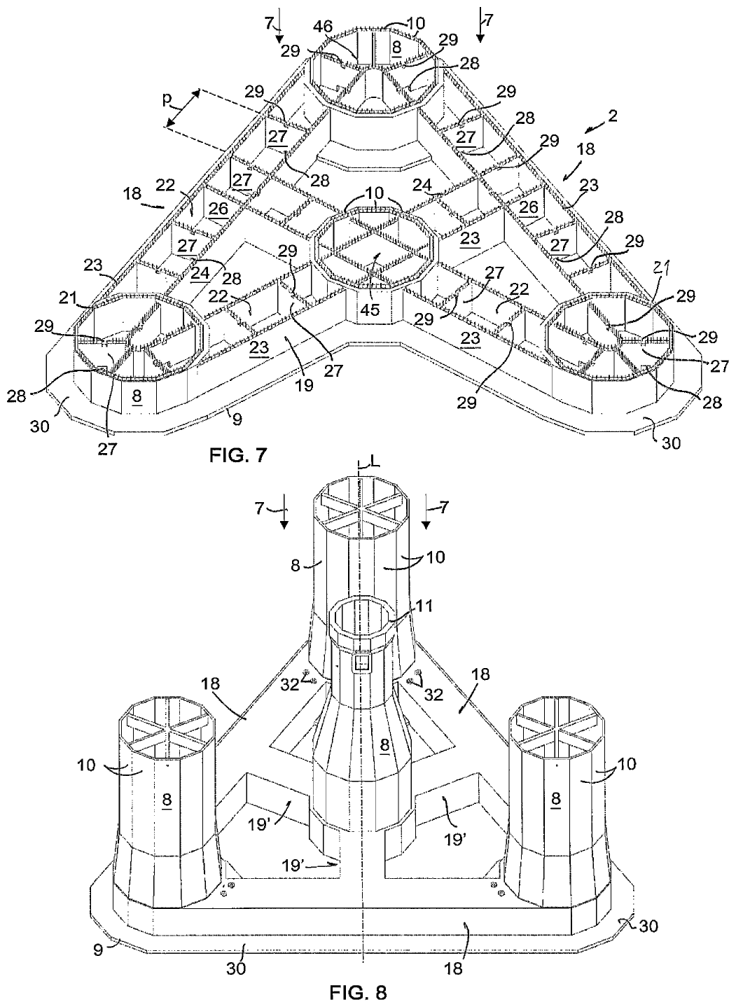

As better illustrated in FIGS. 6 and 7, the main connection arms 18 are positioned along directions X which substantially intersect at the longitudinal axis L (in turn passing through the forward vertex 3 of the support base 2).

The X directions are angularly spaced from each other by an angle α not less than 60°.

From the simulations carried out on the platform which is the object of the present invention it was possible to verify that an angle α greater than 60° enables the reduction of the lateral (rolling) oscillations of the platform 1 when the latter is oriented with its axis L parallel to the prevailing direction of the waves 7.

This embodiment is particularly advantageous if at the installation site the waves and the wind act in their prevailing direction 7 and the wind turbine operates with the rotor misaligned with respect to the wind direction.

Preferably, the two main connection arms 18 may have the same length l so as to define a support base 2 with a substantially “symmetrical arrow” shape in which the point is formed by two sides with the same length.

The secondary connection arms 19, 19′ allow the intermediate point 6 (or the vertical body 8 obtained on this point) to be connected to the pair of vertices 4, 5.

The embodiment of the invention illustrated in FIG. 2 shows two series of secondary connection arms.

The secondary connection arms belonging to the first series, indicated with the reference number 19′, allow the connection of the intermediate point 6 of the support base 2 (or the vertical body 8 placed at the intermediate point 6) with the main connection arms 18.

The secondary connection arms belonging to the second series, indicated with the reference number 19, allow the connection of the intermediate point 6 (or the vertical body 8 placed at the intermediate point 6) with the vertical bodies 8 placed at the vertices 4, 5.

Conveniently, the secondary connection arms 19′ of the first series extend to the same level as the main connection arms 18.

Therefore, both these types of connecting arms (main arms 18 and secondary arms of the first series 19′) rest on the slab 9 (that is, they extend upwards starting from the slab 9). As already described above, the slab 9 defines the supporting wall for the load-bearing elements of the platform 1, in the specific case for the main arms 18 and for the first series of secondary arms 19′.

Conveniently, as better illustrated in the Figures, the secondary connection arms 19′ of the first series extend along a rectilinear direction between two ends; one of these ends is connected to the intermediate point 6 (or to the vertical body 8 positioned at this point) and the other end is connected to the main connection arm 18.

Advantageously, the secondary connection arm 19′ of the first series may extend along a rectilinear direction selected in such a way as to anchor one of its ends to the main connection arm 18 at the central position of the latter.

In other words, the secondary connection arm 19′ of the first series can be connected in the area of the main connection arm 18 corresponding to half (l/2) of its length l.

This embodiment guarantees high stability to the platform and helps to minimize the stresses exerted by the waves and wind flowing in the prevailing direction of the wind turbine.

Conveniently, the secondary connection arms 19 of the second series (suitable for connecting the intermediate point 6 to the vertical bodies 8 associated with the vertices 3, 4, 5) may also extend along a substantially rectilinear direction and be at the same level as the main connection arms 18.

Therefore, also in this case, the secondary connection arms of the second series rest on the slab of the support base 2, that is, they extend upwards from the slab 9.

Consequently, as better illustrated in the Figures, the main support arms 18, and the secondary support arms 19, 19′ of the first and second series may all be at the same level (and therefore all rest on the slab 9).

According to an alternative embodiment, illustrated in FIGS. 8 to 10, the support base 2 of the platform may have three main connection arms 18 suitable to connect all the vertices 3, 4, 5 to each other (so as to define a triangular shape of the platform 1) and three secondary arms 18′ intended to connect the vertical body 8 located at the intermediate point 6 with the respective main connection arms 18.

In this case, a further secondary arm 19′ of the first series may be provided to connect the intermediate point 6 to the main arm 18 which connects the vertices 4 and 5.

This secondary arm 19′ may also extend along a rectilinear direction intersecting the substantial center line of the main connection arm 18′.

Therefore, in this case, one end of the secondary connection arm 19′ is secured to the intermediate point 6 (or to the vertical body 8 located at that point) while the other end is connected to the main arm 18 in the area of the same, positioned at half (l/2) the distance of its length l.

As better seen in FIGS. 7 and 10, the main arms 18 and the secondary arms 19, 19′ have a substantially square or rectangular sectional shape suitable for enclosing an internal cavity 22.

Each arm 18, 19, 19′ has a pair of side walls 23, 24, a lower wall defined by the slab 9, and an upper covering wall 25.

As better seen in FIG. 7, the load-bearing support base 2 can be strengthened by inserting transverse walls 26, 27 located inside the internal cavity 22 of each arm 18, 19, 19′.

In particular, these transverse walls 26, 27 can be arranged so as to be offset along the direction of extension of the arm 18, 19, 19′ with a substantially constant pitch p.

Some transverse walls may be totally closed and without openings (these walls are indicated in FIG. 7 with reference number 26).

In practical terms, these closed transverse walls 26 are diaphragms capable of dividing the cavity 22 of the corresponding arms 18, 19, 19′ into two watertight compartments.

Further transverse walls 27 may have a lower opening 28 and an upper opening 29. As will be better described below, the lower opening 28 will allow the passage of water inside the cavity 22 of each compartment to fill it completely, when necessary. The upper opening 29 will enable the air present inside the cavity 22 of each compartment to escape when being filled with water.

Conveniently, the size of the lower openings 28 can be large enough to enable access by a person to inspect the cavity 22 and the arms 18, 19, 19′ during the construction of the support base 2, and subsequent to its construction.

The load-bearing support base of FIG. 7 shows a pair of transverse diaphragms 26 suited to divide each main arm 18 into two compartments.

The division of each main arm 18 into two mutually watertight compartments (isolated from each other by the transverse diaphragm 26) enables the construction of a particularly flexible structure since it will be possible to fill each compartment with sea water in a substantially independent manner from the other.

Furthermore, each compartment will have a volume substantially equal to half the volume defined by the cavity 22 present inside each single main connection arm 18.

Therefore, the introduction of the diaphragm 26 enables the cavity of each main connection arm to be divided into two half-cavities.

In this case it will in fact be possible to keep a half-cavity of the cavity 22 empty and dry (or to empty it, if it had previously been filled with sea water) without consequences on the state of the other half-cavity (which can also be empty or, on the contrary, be partially or totally filled with sea water).

This embodiment enables any type of operation to be conducted on each half-cavity when empty (for example maintenance or other activities of a different nature).

The slab 9 of the support base 2 may define a transversely protruding outer edge 30 which extends at least along a portion of the main arms 18 and/or of the secondary arms 19, 19′ and/or of the vertical bodies 8.

In the configuration of the support base 2 illustrated in the Figures, the outer edges 30 extend (peripherally) along the entire perimeter of the platform 1 (thus surrounding all the connection arms 18, 19 and all the vertical elements 8).

The outer edges 30 increase the flat surface of the peripheral lower face of the support base 2 and permit a significant increase in the damping of the vertical undulating motions of the platform in the water.

As better schematized in FIG. 4, on the protruding outer edges 30 it will be possible to install one or more marine energy converters, schematically indicated with the reference number 31.

According to a possible embodiment among the many which are admissible, these generators 30 may be configured to generate energy starting from the air flow developed by the wave motion due to the interaction of the sea waves with a membrane positioned near the outer edges 30 and positioned at the main arms 18.

The air flow generated by this interaction can then be conveyed through one or more ducts (not shown in the Figures but which can be integrated in the main arms 18) into an energy conversion system (not shown in the Figures either) comprising a turbine operatively connected to a generator (in turn connected to the electrical system of the main turbine).

From an operational standpoint, the support base 2 and the vertical bodies 8 can be constructed in a shipyard, in which case, once the work is completed, the entire platform 1 can be towed to the offshore system installation site.

To improve the stability of the platform 1 (or of the entire assembled system) during towing from the construction site to the installation site, it is possible to fill the compartments obtained in the cavities 22 of the arms 18, 19, 19′ of the support base 2 with water.

This is possible thanks to the fact that, as noted, the transverse walls 27 inside each compartment of the arms 18, 19, 19′ are equipped with two openings 28, 29 (one at the bottom for the inlet of water and one at the top for venting the air) and that the upper wall 25 of the arms 18, 19, 19′ is equipped with valves 32 to be opened after the platform 1 is launched in order to allow sea water to enter the support base 2. These walls 25 also have air vent pipes 32, the tops of which protrude from the sea level.

Manholes can be located in the upper wall 25 of the arms 17, 18, at the valves 32, which can be used to access the inside of the arms for maintenance and inspection purposes.

Preferably, in order to obtain maximum stability during the towing process of the platform (or of the entire assembled platform) into the sea, it is also possible to partially fill the hollow bodies 8 positioned on the vertices 3, 4, 5 with the same quantity of sea water.

Inside these vertical bodies 8 there are two pipes 33, 34 (generally capped) which extend from the bottom wall 9 to beyond the lid 12. Water may be introduced into the bottom of the corresponding vertical body 8 through the pipes 33, while it is possible to drain the water when the platform 1 is completely installed with the other pipes 34 (to which the pumps 35 are associated).

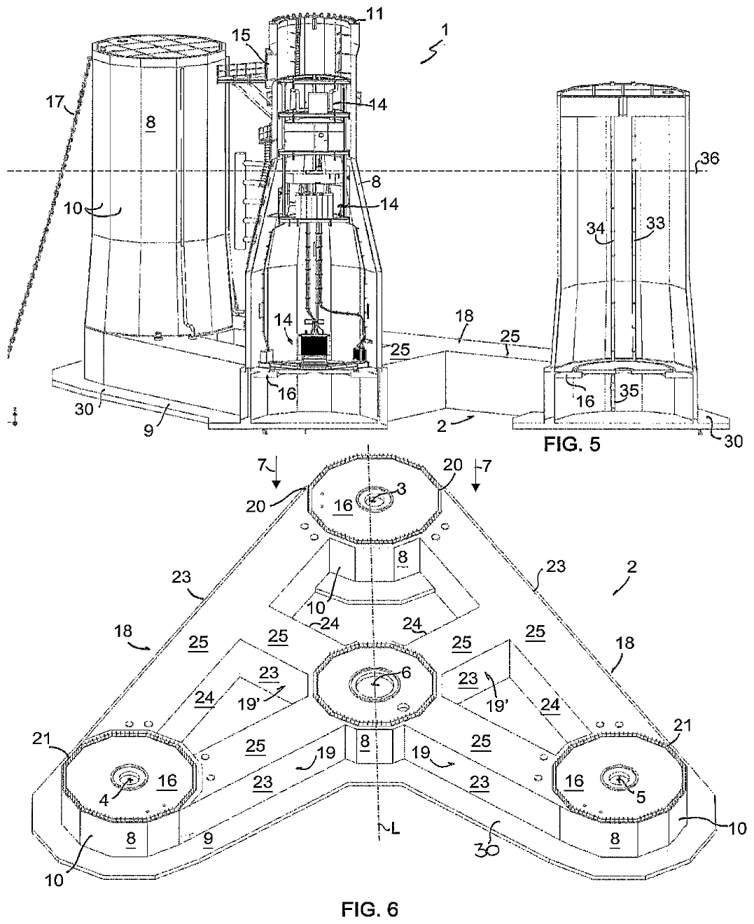

During operation, the platform 1 will have a definitive submerged position with respect to sea level; in particular, the support base 2 and most of the hollow vertical bodies 8 are intended to remain underwater as shown in FIG. 5 (the dashed line indicated with reference number 36 indicates the water level).

Conveniently, the support base 2 and the vertical bodies 8 may be made of reinforced concrete cast on site, with precast concrete elements or with a mixed solution (provided that the design and the construction process guarantee the watertight integrity of the cylindrical bodies and the structural characteristics of the platform in terms of fatigue resistance and load limits).

Any water inlets can be monitored by sensors located on the bottom of the vertical bodies 8 (not shown in the Figures).

The particular “arrow” shape of the platform 1 which is the object of the present invention (with respect to the prevailing direction of the waves and the wind) enables it to resist fatigue cycles for a duration of fifty years.

These properties can be achieved through the optimization of the thicknesses, the choice of suitable concrete, the sizing of the metal reinforcements, and the use of post-tensioning cables in the most stressed areas.

According to a further aspect of the invention, a method for the construction of the semi-submersible floating platform described herein is provided.

This method is aimed at speeding up the platform 1 construction phases and reducing construction costs.

Conveniently, the method is based on the use of flat formwork panels (or elements) 37 designed and manufactured to be reusable over time (for hundreds of platforms) and with dimensions compatible for transport by containers. This is made possible by the particular configuration of the platform 1 which is characterized by the presence of walls exclusively made with the use of flat elements.

In step a) of the method, a plurality of formwork panels 37 is provided.

The method includes a step b) where steel reinforcements 38 formed by interlaced steel bars are provided for, each steel reinforcement 38 having one pair of substantially parallel outer sides.

Advantageously, the formwork panels 37 and the steel reinforcements 38 are pre-assembled before being sandwiched individually or in sets of unitary assemblies of the same height (visible in FIG. 10).

A unitary assembly, globally indicated with the reference number 39, consists of the two formwork panels 37 (placed respectively inside and outside the wall to be built), the frame of the steel reinforcement 38 and the necessary transverse tie rods 40 designed to keep the formwork panels 37 stably against the frame of the steel reinforcements 38 (suitably spaced from the latter).

During step c) of the method, a plurality of tie rods 40 is provided and there is also a step d) for positioning a pair of flat formwork panels 37 outside the sides of a steel reinforcement 38.

The ends of the steel reinforcements of each unitary assembly protrude from the formwork panels 37 so as to be connected to the protruding bars of the adjoining unitary assemblies.

During step e) of the method, the pair of formwork panels 37 are secured to the reinforcement 38 by means of tie rods 40 so as to obtain a unitary assembly 39 with the reinforcement 38 sandwiched between them, the latter of which is also secured to the formwork panels 37 through a plurality of spacers (not shown in the Figures).

The formwork panels 37 and the reinforcements 38 used in a unitary assembly 39 have different shapes and sizes but with a minimum number of types in order to obtain a valid compromise between i) the optimization of the distribution and weight of the reinforcements and ii) the speeding up and simplification of the prefabrication in general and the prefabricated components of the entire platform.

The method also includes a step f) repeating steps a) to e) in order to assemble a pre-specified number of unitary assemblies 39 obtained from the unitary assemblies necessary for the construction of the entire platform 1.

The method also includes the prefabrication of concrete slabs intended to make up the upper sides of the arms and some reinforcements; it is also advantageous to provide connection joints 41, 42 for the formwork panels 37 installed side by side.

In step g) of the method a reinforced concrete slab 9 is provided, the shape of which is in agreement with the plan view shape of the support base 2, said slab also being provided with a plurality of protruding steel bars 43.

In a preferred construction method, after the base slab 9 of the support base 2 is made, the first layer of unitary assembly 39 is mounted on it for the construction of the vertical walls of the support base 2 and the lower parts of the vertical bodies 8.

In particular, the method includes a step h) for arranging the unitary assemblies on the slab 9 in a side-by-side position and with the protruding steel reinforcements 38 connected to each other and to the steel bars 43 of the slab 9 so as to define a plan view shape corresponding to the vertical walls of the support base 2.

There is also a subsequent step i) for the mutual connection of the formwork panels 37 arranged side by side to eliminate the spaces between the formwork panels 37 and the concrete base slab 9. The connection of the formwork panels 37 to the base slab 9 takes place through the use of joints 44 while the reciprocal connection between the formwork panels 37 takes place through the use of joints 42.

During step j) the concrete is cast inside the unitary assemblies so as to bury the reinforcements 38 of each unitary assembly 39.

Subsequent to the construction of the vertical walls of the support base 2, the formwork panels 37 used to make the vertical walls of the arms (step k) are removed and then the covers 25 of the arms 18, 19, 19′ and the annular stiffening elements 16 of the vertical bodies 8 are constructed with prefabricated concrete elements (step l) and finally the prefabricated concrete stiffening elements are constructed (step m).

In step n) the bottoms of the vertical bodies are constructed using prefabricated concrete stiffening elements.

At this point it will be possible to start constructing the vertical bodies 8 starting from the support base 2.

The unitary assemblies 39 or pre-assembled unitary assembly sets 39 can then be assembled on the bottoms of the vertical bodies 8, operating in parallel from four distinct positions (each corresponding to a respective vertical body 8).

Therefore, in step j), the casting takes place in four different positions.

The construction proceeds in this manner with the subsequent layers until the completion of the platform 1; at the end of the works, the formwork panels 37 are dismantled proceeding from top to bottom; while the post tension cables must be tensioned at the specified time.

In order to carry out what has been described above, the method involves a step o) involving the repetition of the steps from h) to j) to create the remaining concrete layers of the vertical bodies 8.

The thickness of the first layer of the platform depends on the height of the arms that is necessary. The thickness of the other layers is determined so as to have light formwork panels, unitary assemblies which are easily handled with small cranes so as to facilitate the casting of the concrete.

Finally, in step p) the formwork panels 37 used to make the main bodies are removed, said removal involving the disassembly of the panels from top to bottom.

The present invention can be implemented in other variant embodiments, all of which are within the scope of the inventive characteristics claimed and described herein; these technical characteristics may be replaced by different but technically equivalent elements and materials; the shapes and dimensions of the invention can vary as long as they are compatible with its purpose.

The reference numbers and signs included in the claims and description have the sole purpose of facilitating the comprehension of the explanations and must not be considered elements that limit the technical interpretation of the objects or processes indicated by them.

1. A floating platform (1) for supporting offshore structures intended to generate electric power, said platform comprising:
a load-bearing support base (2) made of concrete and defining a longitudinal axis (L), said base (2) being provided with three vertices (3, 4, 5) and an intermediate point (6) located in proximity to its geometric center;
a plurality of vertical bodies (8) made of concrete and extending from said support base (2), at said vertices (3, 4, 5) and at said intermediate point (6);
wherein a vertex (3) of said load-bearing support base (2) is located in a longitudinally forward position with respect to the other two vertices (3, 4);
wherein said load-bearing support base (2) comprises one pair of main connection arms (18) suited to directly connect the vertex (3) in a longitudinally forward position with the other two vertices (3, 4) to substantially define the shape of an arrow, in plan view, for said support base (2),
characterized in that it comprises a first series of secondary connection arms (19′), each one of which is suited to directly connect the intermediate point (6) of said load-bearing support base (2) to a corresponding main connection arm (18).

2. The floating platform as claimed in claim 1, characterized in that each secondary connection arm (19′) of said first series is suited to connect said intermediate point (6) to the corresponding main connection arm (18) substantially at the midpoint of the latter.

3. The floating platform as claimed in claim 1, characterized in that said main connection arms (18) are arranged along respective directions (X) which intersect substantially at the vertex (3) of said base (2) located in a longitudinally forward position and are angularly spaced with an angle (α) not smaller than 60°.

4. The floating platform as claimed in claim 1, characterized in that said main connection arms (18) have substantially the same length (l).

5. The floating platform as claimed in claim 1, characterized in that said support base (2) comprises a further main arm (18) suited to connect the vertices (2, 3) arranged in a longitudinally rearward position.

6. The floating platform as claimed in claim 1, characterized in that said load-bearing support base (2) comprises a second series of secondary connection arms (19), each of which is suited to connect said intermediate point (6) to a corresponding vertical body (8) located at said vertices (3, 4, 5).

7. The floating platform as claimed in claim 6, characterized in that said main connection arms (18) and/or the secondary connection arms (19, 19′) of said first series and of said second series respectively have a substantially square or rectangular cross section and an inner cavity (22), said cavity (22) being defined by two pairs of longitudinal parallel walls (9, 25; 23, 24).

8. The floating plat-form as claimed in claim 7, characterized in that said main connection arms (18) and/or said secondary connection arms (19, 19′) of said first series and of said second series comprise a plurality of transverse walls (27) arranged inside said cavity (22) in a longitudinally offset position.

9. The floating platform as claimed in claim 8, characterized in that each of said transverse walls (27) has a lower opening (28) suited to allow the passage of water for filling said cavity (22) and an upper opening (29) suited to allow the escape of the air present in the cavity (22) while the latter is being filled with water.

10. The floating platform as claimed in claim 1, characterized in that said vertical bodies (8) are hollow and have a substantially polygonal cross section in plan view.

11. The floating platform as claimed in claim 1, characterized in that said load-beating support base (2) comprises a slab (9) made of concrete and having a predetermined shape in plan view, said slab (9) being suited to connect the three vertices (3, 4, 5) and said intermediate point (6) to one another.

12. The floating platform as claimed in claim 1, characterized in that said load-bearing support base (2) has a substantially horizontal outer edge (30) obtained on said slab (9) or respectively extending from at least one portion of said main arms (18) and/or from at least one portion of said secondary arms (19, 19′) and/or from at least one portion of said vertical bodies (8).

13. The floating platform as claimed in claim 11, characterized in that it comprises one or more devices (31) waited to generate electric power through the conversion of marine energy.

14. The floating platform as claimed in claim 13, characterized in that said one or more devices (31) for the generation of electric power are arranged along said outer edge (30) of said load-bearing support base (2).

15. A method for making a concrete platform according to claim 6, comprising the following steps:
a) providing a plurality of flat formwork panels (37);
b) providing steel reinforcements (38), each constituted by interlaced steel bars, said reinforcements (38) having one pair of substantially parallel outer sides;
c) providing a plurality of tie rods (40);
d) positioning one pair of flat panels (37) outside the sides of a respective reinforcement (38), with the steel bars of the reinforcement (38) protruding from the edges of said panels (37);
e) mutually assembling said pair of panels (37) through said tie rods (40) to form a unitary assembly (39) with the reinforcement (38) substantially sandwiched between them and locked between the panels (37) through a plurality of spacers;
f) repeating steps from a) to e) so as to obtain a predetermined number of unitary assemblies (39);
g) making a concrete base slab (9) according to the shape of said base (2) in plan view, said slab (9) being provided with protruding steel bars (43);
h) arranging said unitary assemblies (39) on said slab (9) side by side and with the respective protruding steel bars of the reinforcement (38) respectively connected to each other and to the steel bars (43) of the slab (9) to define a plan view shape substantially corresponding to that of the support base (2) and of the arms (18, 19, 19′);
i) mutually connecting the formwork panels (37) of the assemblies (39) arranged side by side in such a way as to eliminate the spaces among the panels (37) and the concrete base slab (9);
j) casting concrete inside said unitary assemblies (30) in such a way as to bury the reinforcement (38);
k) removing the formwork panels (37) used to make the vertical walls of the arms (18, 19, 19′) of the support base (2);
L) making the cover (25) of the connection arms (18, 19, 19′);
m) making prefabricated concrete stiffening elements (16);
n) making the bottoms of the vertical bodies (8) by using said prefabricated concrete stiffening elements (16);
o) repeating steps from h) to j) to create the remaining concrete layers suited to obtain the vertical bodies (8), said step j) including the casting of concrete from four different points, each of which is located at the respective vertical body (8);
p) removing said formwork panels (37) used to make the main bodies (8), said removal being carried out from top to bottom.
